(19) United States
(12) Patent Application Publication
(10) Pub. No.: US 2002/0168019 A1
(43) Pub. Date: Nov. 14, 2002

(54) Apparatus and method to reduce size and complexity of reconstruction filters in a multi-protocol transmitter

(76) Inventors: Erik Bengtsson, Lund (SE); Cong Nguyen, Durham, NC (US)

Correspondence Address: HARRITY & SNYDER, LLP, 11240 WAPLES MILL ROAD, SUITE 300, FAIRFAX, VA, 22030, US

(21) Appl. No.: 09/851,317

(22) Filed: May 9, 2001

(51) Int. Cl. H04L 27/04

(52) U.S. Cl. 375/295; 455/102

(57) ABSTRACT

Transmitting systems and methods for multiple access protocols consistent with the present invention include device(s) to increase data rates in at least two portions that generate different access protocols. The increased data rates cause noise generated by Σ-Δ converters in the at least two portions to occupy high frequencies, enabling the at least two portions to share common reconstruction filters. Shifting the noise in such a manner also allows the use of wide bandwidth common reconstruction filters.

### BACKGROUND OF THE INVENTION

The present invention relates generally to systems and methods for transmitting signals and, more particularly, to such systems and methods that relate to transmitters for multiple access protocols.

Mobile terminals increasingly support more than one access protocol, e.g., Advanced Mobile Telephone System (AMPS), Digital Advanced Mobile Telephone System (DAMPS), Global System for Mobile communication (GSM), and/or Enhanced Data for GSM Evolution (EDGE). A mobile terminal that supports two or more access protocols should be able to transmit signals corresponding to the requirements of each such protocol.

FIG. 1 is a conventional transmitting system 100 for supporting two access protocols. The transmitting system 100 may include a first waveform generating portion 110, a first In-phase and Quadrature (I-Q) filter 120, a first amplitude filter 130, a second waveform generating portion 140, a second I-Q filter 150, a second amplitude filter 160, and a combining device 170. The first waveform generating portion 110 and the second waveform generating portion 140 may include a digital waveform generator, an interpolator, and a converter to produce digital waveforms (not shown). The digital waveforms typically include an in-phase (I) signal and a quadrature (Q) signal. The waveforms may or may not include an amplitude signal, depending on whether the particular access protocol being supported specifies an amplitude signal. For example, DAMPS and EDGE include an amplitude signal, while AMPS and GSM do not.

The first and second I-Q filters 120 and 150, and the first and second amplitude filters 130 and 160 if present, may include passive or active low pass filters. Typically, these filters are passive and have a fixed bandwidth that may vary from filter to filter. The combining device 170 may include, for example, a switch that chooses either the outputs from filters 120 and 130 or the outputs from filters 150 and 160. The signal output by the combining device 170 may be further modulated, amplified, and transmitted from an antenna (not shown).

The transmitting system 100 may be utilized by a conventional mobile terminal to support two access protocols. The first and second waveform generating portions 110 and 140 generate digital waveforms consistent with a first access protocol and a second access protocol, respectively. As conventionally implemented, phase waveforms in the first and second waveform generating portions 110 and 140 may be filtered by the first and second I-Q filters 120 and 150, respectively. Amplitude waveforms in the first and second waveform generating portions 110 and 140 may be filtered by the first and second amplitude filters 130 and 160, respectively. The filters 120, 130, 150, and 160 may be termed “reconstruction” filters, because they reconstruct an analog signal from the generated digital waveforms. The combining device 170 combines filtered signals from the filters 120 and 130, or from the filters 150 and 160, for transmission.

FIG. 2 is an exemplary frequency domain plot 200 to illustrate another function performed by the low pass filters in addition to reconstructing analog signals. Signal spectrum 210 represents a spectrum of a desired analog signal. However, because the waveform generating portion 110, for example, generates a digital signal, some converter noise 220 is added to the desired spectrum 210. Such converter noise 220 typically results from quantization steps present in the digital signal output from the waveform generating portion 110.

Spectrum mask 230 represents an outer spectral envelope specified by a particular access protocol (e.g., DAMPS). To conform to the access protocol, a transmitted signal must be within the spectrum mask 230. Low pass filter attenuation 240 represents the spectral characteristics of, e.g., I-Q filter 120. This attenuation 240 is necessary to force the combination of the signal spectrum 210 and the converter noise 220 to fall within the spectrum mask 230, and thereby conform to the access protocol.

Conventionally, the transmitting system 100 that supports two protocols needs at least two sets of filters (i.e., 120/130 and 150/160) due to different bandwidth requirements of these protocols. For example, for the phase branch in one implementation of two exemplary protocols, DAMPS would need a 100 kHz low pass filter, and EDGE would need a 500 kHz low pass filter. For the amplitude branch in this implementation of the two exemplary protocols, DAMPS would need a 100 kHz low pass filter, and EDGE would need an 500 kHz low pass filter. The I-Q filters 120 and 150 are needed to handle the two different bandwidths in the phase branches (i.e., 100 kHz and 500 kHz). Similarly, the amplitude filters 130 and 160 are needed to handle the two different bandwidths in the amplitude branches (i.e., 100 kHz and 500 kHz).

### BRIEF SUMMARY OF THE INVENTION

In accordance with the purpose of the invention as embodied and broadly described herein, a transmitter for processing signals in accordance with two or more access protocols may include a first digital waveform generator to generate a plurality of first digital waveforms from first transmission data in accordance with a first access protocol. The transmitter also may include a second digital waveform generator to generate a plurality of second digital waveforms from second transmission data in accordance with a second access protocol. One or more common reconstruction filters coupled to both the first and second digital waveform generators receive one of the first and second digital waveforms and output one or more analog waveforms.

In another implementation consistent with the present invention, a method for filtering signals in a transmitter comprising one or more common reconstruction filters for two or more access protocols, may include generating a plurality of first waveforms from first transmission data in accordance with a first access protocol and generating a plurality of second waveforms from second transmission data in accordance with a second access protocol. The method also may include filtering, by the one or more common reconstruction filters, one of the first and second waveforms to produce an analog waveform.

In a further implementation consistent with the present invention, a transmitter in a mobile terminal may include a plurality of waveform generators, each waveform generator generating a waveform from transmission data according to a different access protocol. A common reconstruction filter coupled to each of the plurality of waveform generators may receive a waveform from one of the plurality of waveform generators and may filter the received waveform.

### BRIEF DESCRIPTION OF THE DRAWINGS

The accompanying drawings, which are incorporated in and constitute a part of this specification, illustrate embodiments of the invention and, together with the description, explain the invention. In the drawings,

FIG. 1 is a block diagram of a conventional transmitting system for supporting two access protocols;

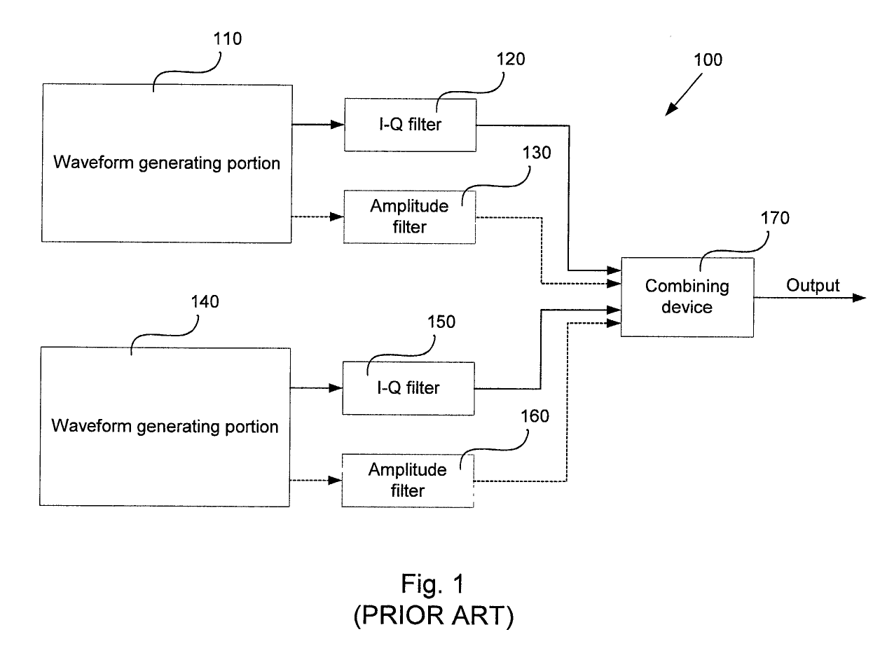

FIG. 2 is an exemplary frequency domain plot to illustrate operation of the low pass filters of FIG. 1;

FIG. 3 is a block diagram of an exemplary transmitting system consistent with the present invention for supporting three access protocols;

FIG. 4 is a flow chart illustrating exemplary processing consistent with the present invention for an access protocol;

FIG. 5 is a frequency graph of spectra produced by the converters in FIG. 3; and

FIG. 6 is a block diagram of an exemplary portion of a transmitting system consistent with the present invention for supporting three access protocols.

### DETAILED DESCRIPTION OF THE INVENTION

The following detailed description of the invention refers to the accompanying drawings. The same reference numbers in different drawings identify the same or similar elements. Also, the following detailed description does not limit the invention. Instead, the scope of the invention is defined by the appended claims and equivalents.

Transmitting systems and methods for multiple access protocols consistent with the present invention include device(s) to increase data rates in portions that generate the multiple access protocols. The increased data rates cause noise generated by Σ-Δ (sigma-delta) converters in these portions to occupy high frequencies, enabling the portions that generate the multiple access protocols to share common reconstruction filters. Shifting the noise also allows the use of wide bandwidth common reconstruction filters.

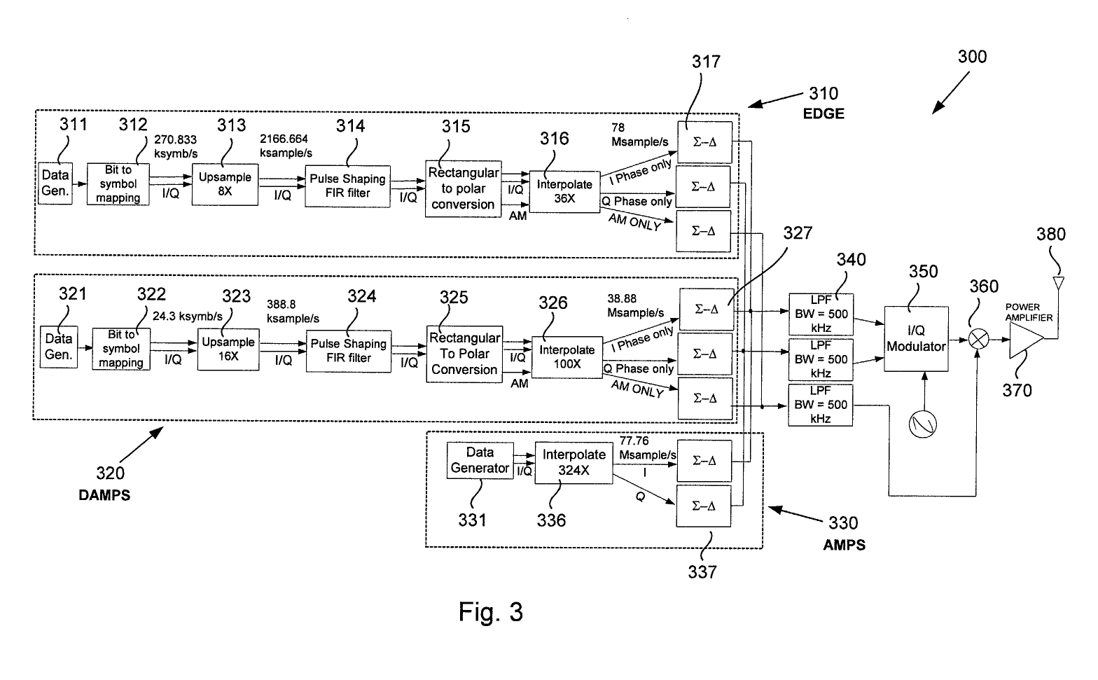

FIG. 3 is a block diagram of an exemplary transmitting system 300 in a mobile terminal consistent with the present invention for supporting three access protocols, namely EDGE, DAMPS, and AMPS. While the support of three access protocols is described below, it will be appreciated that a transmitting system consistent with the present invention is not so limited. In alternative implementations, the transmitting system 300 may be configured to handle more or less than three access protocols. Moreover, the transmitting system 300 may support access protocols other than EDGE, DAMPS, and AMPS.

The transmitting system 300 may include an EDGE generating portion 310, a DAMPS generating portion 320, an AMPS generating portion 330, common reconstruction filters 340, an I/Q modulator 350, a direct amplitude modulator 360, an amplifier 370, and an antenna 380.

The EDGE generating portion 310 and the DAMPS generating portion 320 may each include a data generator 311/321, a symbol mapping device 312/322, an upsampling device 313/323, a pulse shaping Finite Impulse Response (FIR) filter 314/324, an interpolator 315/325, a rectangular-to-polar converter 316/326, and three Σ-Δ (sigma-delta) converters 317/327. The AMPS generating portion 330 may include a data generator 331, an interpolator 335, and two Σ-Δ (sigma-delta) converters 337.

The data generators 311/321/331 may include a microprocessor or digital signal processor to generate data for transmission in accordance with their particular access protocol. In the configuration shown, the data generators 311 and 321 may each generate a binary stream of ones and zeros consistent with their respective EDGE and DAMPS access protocols. The data generator 331 may include a digital signal processor that produces in-phase/quadrature (I/Q) symbols at a rate of, for example, 240 kilosymbols/second in accordance with the AMPS access protocol.

The symbol mapping devices 312/322 may receive the binary data from the generators 311/321. The symbol mapping devices 312/322 may include logic circuits or application specific integrated circuits (ASICs) to convert the received binary data into two-dimensional I/Q symbols, as is known in the art. The symbol mapping device 312 may, for example, produce 270.833 kilosymbols/second in accordance with the EDGE access protocol, and the symbol mapping device 322 may, for example, produce 24.3 kilosymbols/second in accordance with the DAMPS access protocol.

The upsampling devices 313/323 may receive the symbol data from the symbol mapping devices 311/321. The upsampling devices 313/323 may include logic circuits or ASICs to sample the received data at a multiple of its symbol rate, as is known in the art. For example, the upsampling devices 313/323 may include an internal clock synchronized with the input symbols to produce an integer multiple of samples (e.g., 8) of each input signal. In an implementation consistent with the present invention, the upsampling device 313 may sample its input at eight times the input symbol rate to produce an output at 2166.664 kilosamples/second. The upsampling device 323 may, for example, sample its input at sixteen times the input symbol rate to produce an output at 388.8 kilosamples/second.

The pulse shaping FIR filters 314/324 may receive the upsampled data from the upsampling devices 313/323. The pulse shaping FIR filters 314/324 may include a digital filter having a finite impulse response to restrict the bandwidth of the upsampled data. For example, the pulse shaping FIR filters 314/324 may digitally remove very abrupt transitions in the upsampled data from the upsampling devices 313/323, in effect “smoothing” rough edges in the data.

The rectangular-to-polar converters 315/325 may receive the digitally filtered data from the pulse shaping FIR filters 314/324. The rectangular-to-polar converters 315/325 may include digital logic or one or more ASICs to convert the interpolated I/Q input signals (i.e., rectangular coordinates) into I/Q phase-only signals and an amplitude signal (i.e., polar coordinates). Such conversion may be performed to facilitate direct modulation by the direct amplitude modulator 360. However, if direct amplitude modulation is not desired, the rectangular-to-polar converters 315/325 may be omitted.

The interpolators 316/326 may receive the digitally modified data from the rectangular-to-polar converters 315/325. The interpolator 336 may receive data directly from the data generator 331. The interpolators 316/326/336 may include a digital filter to interpolate between adjacent samples. For example, the interpolators 316/326 may include one or more filters to linearly interpolate by “filling in” some number of values between adjacent samples. The interpolator 316 may, for example, interpolate 36 points per symbol to produce an output at 78 megasamples/second. The interpolator 326 may, for example, interpolate 100 points per symbol to produce an output at 38.88 megasamples/second, and the interpolator 336 may interpolate 324 points per symbol to produce an output at 77.76 megasamples/second.

The Σ-Δ converters 317/327 may receive the interpolated data from the interpolators 316/326. The Σ-Δ converter 337 may receive data directly from the interpolator 336. The Σ-Δ converters 317/327/337 may include 1-bit converters that produce binary, digital outputs from the converted data in a conventional manner. For example, Σ-Δ converters 317/327/337 may convert, e.g., 8-bit parallel input words into a stream of single output bits at the same bit rate, depending on a relative change (i.e., higher or lower) between successive input words. Depending on which access protocol currently transmits data, one set of the outputs from the Σ-Δ converters 317/327/337 may be connected to filters 340 by, for example, digital switches (not shown).

The common reconstruction filters 340 may receive the converted data from the Σ-Δ converters 317, 327, or 337. The common reconstruction filters 340 typically include active or passive fixed-bandwidth low-pass filters, which may have a cut-off frequency of 500 kHz in the exemplary implementation of FIG. 3. It will be appreciated that other cut-off frequencies may alternatively be used. The filters 340 may be termed “common,” because they may be used as reconstruction filters for any of the EDGE generating portion 310, the DAMPS generating portion 320, and the AMPS generating portion 330.

The I/Q modulator 350 may receive reconstructed analog signals from two filters 340, and may output a modulated signal to the direct amplitude modulator 360. The direct amplitude modulator 360 may modulate the received signal from the I/Q modulator 350 with a reconstructed, analog, amplitude signal from the third filter 340. The power amplifier 370 may amplify the power level of the directly modulated signal from the amplitude modulator 360 for transmission from the antenna 380.

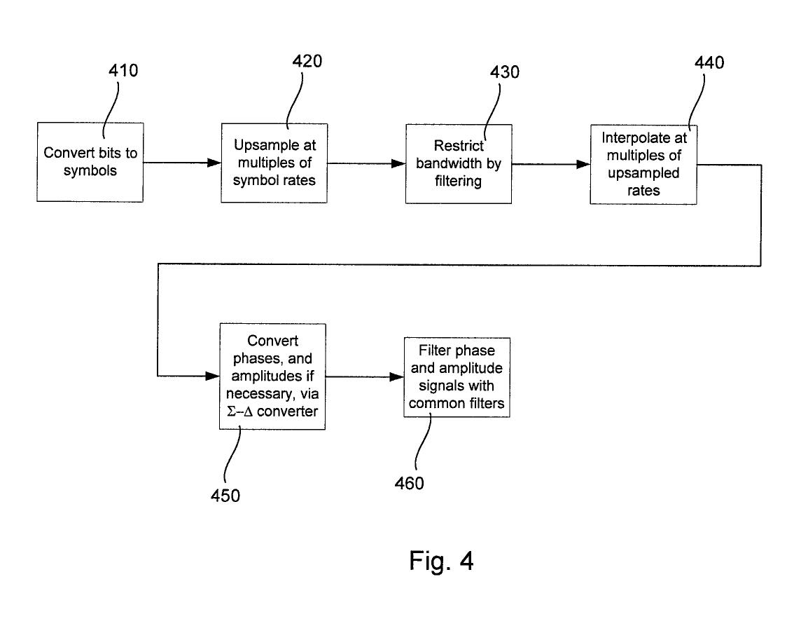

FIG. 4 is a flow chart illustrating exemplary processing for an access protocol (e.g., the DAMPS portion 320 in FIG. 3) consistent with the present invention. The symbol mapping device 322 may convert its received binary data into two-dimensional I/Q symbols [step 410]. The symbol mapping device 322 may, for example, map the ones and zeros received onto a two-dimensional I/Q plane. The resultant symbol rate may be dictated by the particular access protocol implemented, for example 24.3 kilosymbols/sec for DAMPS.

Next, the upsampling device 323 may sample its input symbols at sixteen times the input symbol rate to produce an output at 388.8 kilosamples/second [step 420]. Other multiples than sixteen may be used. The upsampling (also known as over-sampling) is typically performed at a frequency that is some multiple of the symbol rate, which leads to aliased images in the spectrum at multiples of this over-sampling frequency. By increasing the over-sampling rate, the upsampling device 323 pushes the aliased images out in frequency so that they can be suppressed by wider bandwidth analog filters. For example, for DAMPS, the over-sampling may be performed at 8*24.3 kHz. This creates images at multiples of 194.4 kHz. These images will not be suppressed by a filter 340 whose bandwidth is, for example 200-300 kHz, that may be needed for another access protocol. By increasing the over-sampling frequency to 16*24.3 kHz, the aliased images occur at multiples of 388.8 kHz, and some degree of suppression of these images by the reconstruction filters 340 may be expected.

The pulse shaping FIR filter 324 may restrict the bandwidth of the upsampled data [step 430]. For example, the FIR filter 324 may provide a window that is constant over a central portion of the signal to be filtered, but tapers to zero in some pre-determined fashion at the edges of the signal. By an appropriate choice of such tapering, significant improvements in adjacent channel interference, by filtering high frequencies, may be achieved. Though the FIR filter 324 may restrict the bandwidth of the upsampled data, it does not alter its sample rate.

The interpolator 326 may receive the digitally modified data from the rectangular-to-polar converter 325 and may interpolate between adjacent samples [step 440]. The interpolator 326 may interpolate (linearly or otherwise) 100 points per symbol to produce a high-sample-rate output of 38.88 megasamples/second for the Σ-Δ converter 327. The frequency response of the interpolator 326 may be chosen to meet adjacent channel protection/spectral mask requirements of the given access protocol (e.g., DAMPS). For example, a simple interpolation filter (e.g., a linear interpolation filter) that provides very little attenuation in the passband of the reconstruction filters 340 may be sufficient for EDGE. Some cases may require greater attenuation in the passband of the reconstruction filters 340. For these cases, appropriate interpolators may be designed to provide the necessary in-band response. For each modulation format supported, the choice of interpolating mechanism may be chosen appropriately.

The Σ-Δ converters 327 may receive the converted data from the interpolator 326. The Σ-Δ converters 327 may produce binary, digital outputs with the same symbol rate as their inputs [step 450]. In the configuration of FIG. 3, the sampling rate of the Σ-Δ converters 327 (78 Msamples/sec) equals the symbol rate produced by the mapping device (270.833 ksymbols/sec) multiplied by the upsampling multiple of the upsampling device 323 (8 times its input rate), multiplied by the interpolation multiple of the interpolator 326 (36 times its input rate). The Σ-Δ converters 327 inherently shape the quantization noise in their input signals such that low frequency regions have high signal-to-noise ratios (SNR) while high frequency regions have low SNR. Choosing the sample rate of the Σ-Δ converters 327 appropriately (via choosing the upsampling and interpolation multiples) forces the low SNR region beyond the cutoff frequency of the reconstruction filters 340. This choice of a high sample rate results in a high-quality reconstructed signal. The order of the Σ-Δ converters 327 used may also be chosen to shape the quantization noise. A higher order Σ-Δ converter (e.g., second or above) may suppress the spectrum of the noise at lower frequencies. Although such a higher order Σ-Δ converter amplifies the noise at higher frequencies, the reconstruction filters 340 may suppress the higher-frequency noise.

The common reconstruction filters 340 may receive the converted data from the Σ-Δ converters 327 and actively or passively low-pass filter the binary data from the Σ-Δ converters 327 to generate analog signals [step 460]. The bandwidth of this filter 340 should be at least the same or larger than the largest signal bandwidth (e.g., EDGE) but small enough to remove the typical noise that the Σ-Δ converters 327 produce at higher frequencies. By choosing a proper sampling rate of the Σ-Δ converters for each of the EDGE generating portion 310, the DAMPS generating portion 320, and the AMPS generating portion 330, a single filter bandwidth, which is chosen based on the largest signal bandwidth, can be used.

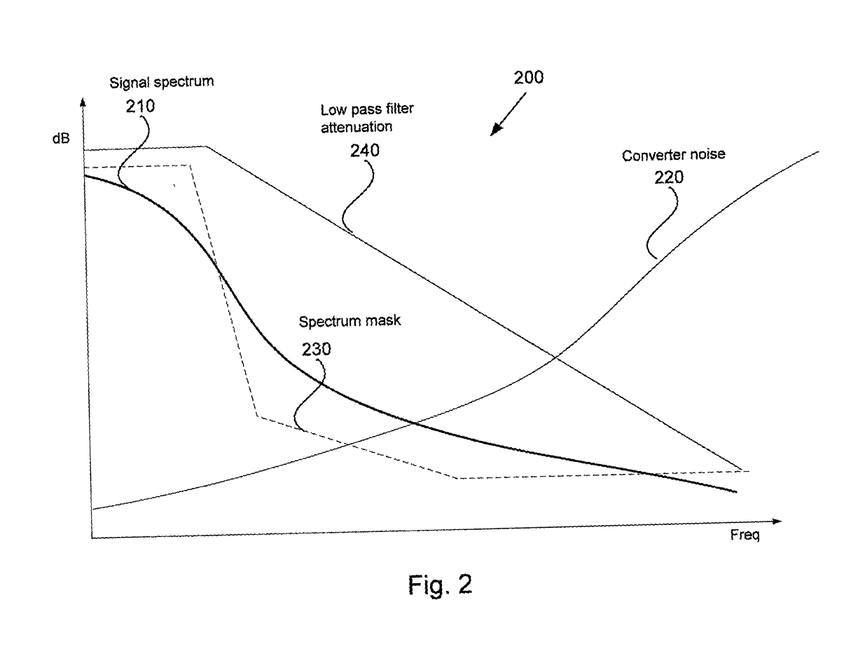

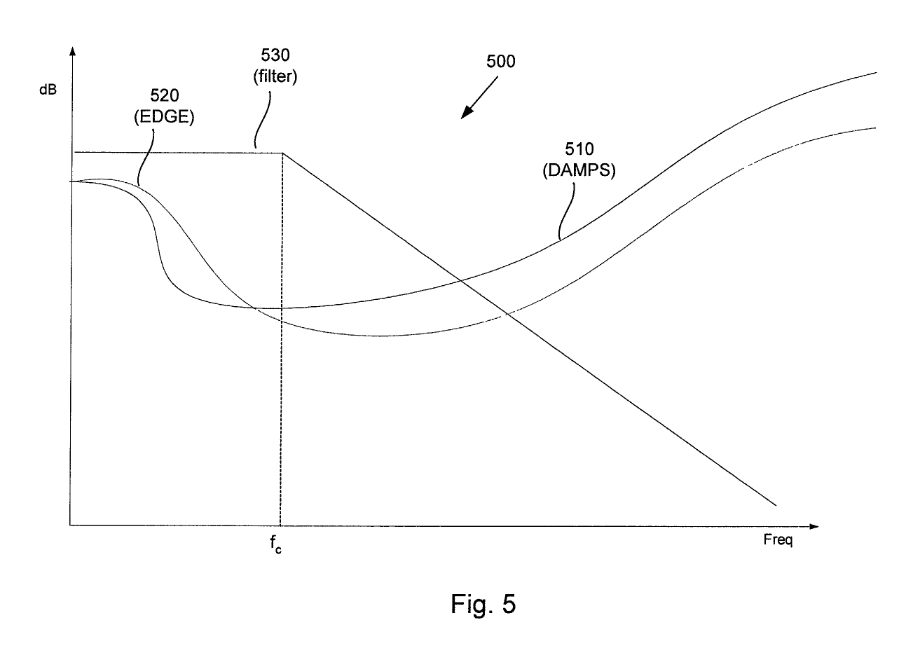

FIG. 5 shows a frequency graph 500 of spectra produced by, for example, Σ-Δ converters 317 and 327 in accordance with an implementation of the invention. The Σ-Δ converter 327 in the DAMPS generating portion 320 may produce a signal having a spectrum 510. The Σ-Δ converter 317 in the EDGE generating portion 310 may produce a signal having a spectrum 520. The common filters 340 may have a low-pass spectral response 530 with a cut-off frequency of f_{c}. The upsampling devices 313/323, the interpolators 316/326, and the Σ-Δ converters 317/327 in the respective generating portions are designed to produce data at a high sampling rate, which produces very little quantization noise at low frequencies. Hence, the spectra 510 and 520 fall within the spectral envelopes (not shown) for the DAMPS and EDGE access protocols within the filter's pass band (0-f_{c} Hz). In a transmitting system so configured, the filters 340 may be utilized by both protocols (e.g., via digital switches that connect one set of converters 317/327 at a time to the common filters 340). Common filters 340 may be used, because tailored filters are not needed to ensure spectral envelope compliance (see FIG. 2) at lower frequencies due to the oversampling and interpolation in the generating portions. The spectral response 530 of the common filters 340 need encompass the highest bandwidth signal, in this case the EDGE spectrum 520, in its pass band. Hence, the common filters 340 may be relatively easy to design and implement due to the relatively large bandwidth (e.g., 400-600 kHz) of the filters.

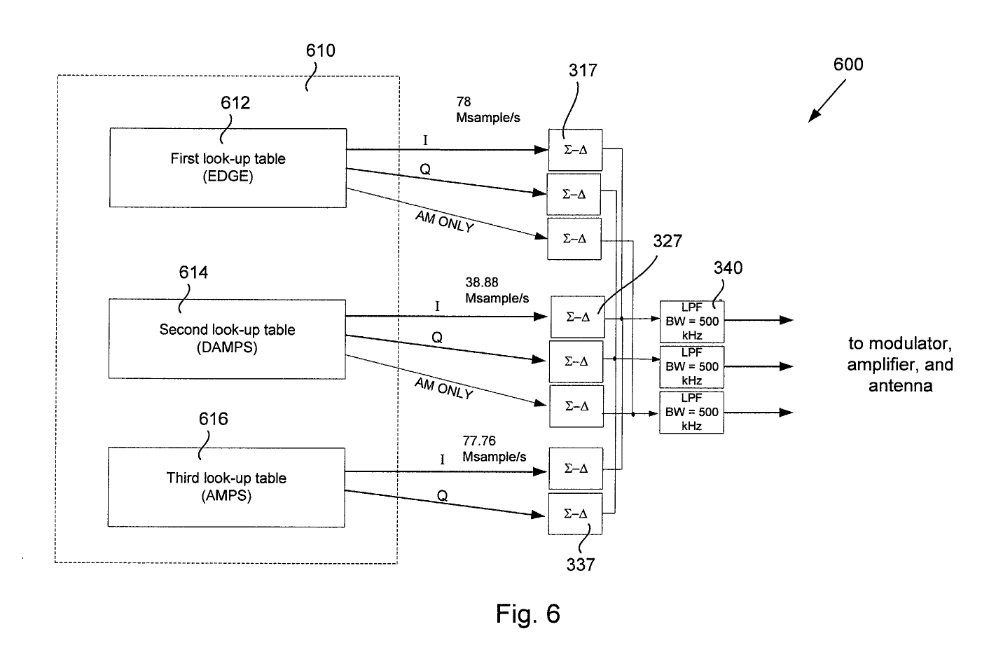

FIG. 6 is a block diagram of a portion of an exemplary alternative transmitting system 600 consistent with the present invention for supporting three access protocols, namely EDGE, DAMPS, and AMPS. The transmitting system 600 may include a memory device 610 containing first through third look-up tables 612/614/616, Σ-Δ (“sigma-delta”) converters 317/327/337, and common reconstruction filters 340. The Σ-Δ converters 317/327/337 and the common reconstruction filters 340 are arranged and function similarly to the same-numbered elements in FIG. 3. For example, one set of Σ-Δ converters 317/327/337 may be connected at a time to the filters 340 by digital switches (not shown). The reconstruction filters 340 may output signals to an I/Q modulator 350, a direct amplitude modulator 360, an amplifier 370, and an antenna 380 as shown in FIG. 3.

The device 610 may include a memory, such as random access memory (RAM), configured to receive data for transmission in accordance with multiple access protocols (not shown) and to produce I/Q phase (and possibly amplitude) data from the look-up tables 612/614/616 consistent with those protocols. The first look-up table 612 may contain data consistent with the EDGE access protocol. Similarly, the second look-up table 614 may contain data consistent with the DAMPS access protocol, and a third portion 616 of the look-up table may contain data consistent with the AMPS access protocol.

Alternately, the look-up tables 612, 614, and 616 may be implemented in separate memory devices instead of in one device 610. In another arrangement, one look-up table at a time (e.g., 612) may be loaded into the memory device 610 from, for example, a read-only memory (ROM), depending on which access protocol is to be used. Those skilled in the art will be able to realize a suitable look-up table implementation, in view of this disclosure and the principles articulated herein.

The use of look-up tables 612/614/616 results from the realization that, for example, the EDGE generating portion 310 (excluding the Σ-Δ converter 317) in FIG. 3 implements a finite number of well-defined digital manipulations on its input data. Hence, the operation of elements 312 through 316 may be digitally simulated on a computer for all possible combinations of input data, and the results may be stored in, e.g., the first portion 612 of the look-up table. Thus, the memory device 610, containing the look-up tables 612/614/616, may replace most of the EDGE, DAMPS, and AMPS generating portions 310, 320, and 330 in FIG. 3, while outputting similar, high-sample-rate data to the Σ-Δ converters 317/327/337.

The foregoing description of preferred embodiments of the present invention provides illustration and description, but is not intended to be exhaustive or to limit the invention to the precise form disclosed. Modification and variations are possible in light of the above teachings or may be acquired from practice of the invention. For example, although one set of common filters has been described for three different access protocols, this invention also contemplates the use of one set of common filters for two access protocols, with or without another set of filters for a possible third access protocol. In other words, the inventors specifically contemplate the use of at least one common reconstruction filter between or among different access protocols in a mobile terminal. The invention is equally applicable to transmitters in stationary (i.e., non-mobile) terminals within communication systems. Further, although the common reconstruction filters have been described as having the same bandwidth, common reconstruction filters having different bandwidths (e.g., for phase and amplitude) may also be used. Further, the bandwidths of the common reconstruction filters may range from 100 kHz to 10 MHz in accordance with the design principles and considerations outlined above.

The present invention is described herein in the context of a mobile terminal. As used herein, the term “mobile terminal” may include a cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

In addition, the present invention is described herein in the context of specific cellular access protocols, namely EDGE, DAMPS, and AMPS. It should be understood that the principles of the present invention may be applied to any cellular or wireless system utilizing other air interfaces, such as GSM, TDMA, CDMA or FDMA. It should be further understood that the principles of the present invention may be utilized in hybrid systems that are combinations of two or more of the above air interfaces. In addition, a mobile terminal, in accordance with the present invention, may be designed to communicate with a base station transceiver using any standard based on GSM, TDMA, CDMA, FDMA, a hybrid of such standards or any other standard. Thus, it is intended that the present invention cover the modifications and variations of the invention provided that they come within the scope of the appended claims and their equivalents.

What is claimed is:

1. A transmitter for processing signals in accordance with two or more access protocols, comprising:
a first digital waveform generator to generate a plurality of first digital waveforms from first transmission data in accordance with a first access protocol;
a second digital waveform generator to generate a plurality of second digital waveforms from second transmission data in accordance with a second access protocol;
one or more common reconstruction filters coupled to both the first and second digital waveform generators to receive one of the first and second digital waveforms and output one or more analog waveforms.

2. The transmitter of claim 1, wherein first access protocol is one of Advanced Mobile Telephone System (AMPS), Digital Advanced Mobile Telephone System (DAMPS), Global System for Mobile communication (GSM), and Enhanced Data for GSM Evolution (EDGE), and
wherein the second access protocol is another one of AMPS, DAMPS, GSM, and EDGE.

3. The transmitter of claim 1, wherein the first waveform generator comprises:
a plurality of first Σ-Δ converters to produce the plurality of first digital waveforms from first interpolated data, and
wherein the second waveform generator comprises:
a plurality of second Σ-Δ converters to produce the plurality of second digital waveforms from second interpolated data.

4. The transmitter of claim 3, further comprising:
a switch to connect one of the first and second digital waveform generators to the one or more common reconstruction filters.

5. The transmitter of claim 3, further comprising:
a memory device to store first and second look-up tables containing data in accordance with the first and second access protocols,
wherein the first digital waveform generator comprises the first look-up table, which maps the first transmission data to the first interpolated data, and
wherein the second digital waveform generator comprises the second look-up table, which maps the second transmission data to the second interpolated data.

6. The transmitter of claim 3, wherein the first digital waveform generator comprises:
a first interpolator to interpolate and increase a first sampling rate of data input thereto and to output the first interpolated data to the plurality of first Σ-Δ converters, and
wherein the second digital waveform generator comprises:
a second interpolator to interpolate and increase a second sampling rate of data input thereto and to output the second interpolated data to the plurality of second Σ-Δ converters.

7. The transmitter of claim 6, wherein the first digital waveform generator comprises:
a first upsampling device to receive and over-sample the first transmission data to output first over-sampled data at the first sampling rate to the first interpolator.

8. The transmitter of claim 7, wherein the second digital waveform generator comprises:
a second upsampling device to receive and over-sample the second transmission data to output second over-sampled data at the second sampling rate to the second interpolator.

9. The transmitter of claim 1, wherein the one or more common reconstruction filters comprise low-pass filters with a bandwidth of 200 kHz or more.

10. The transmitter of claim 9, wherein the one or more common reconstruction filters comprise two low-pass filters with a common bandwidth.

11. A method for filtering signals in a transmitter comprising one or more common reconstruction filters for two or more access protocols, the method comprising:
generating a plurality of first waveforms from first transmission data in accordance with a first access protocol;
generating a plurality of second waveforms from second transmission data in accordance with a second access protocol; and
filtering, by the one or more common reconstruction filters, one of the first and second waveforms to produce an analog waveform.

12. The method of claim 11, wherein first access protocol is one of Advanced Mobile Telephone System (AMPS), Digital Advanced Mobile Telephone System (DAMPS), Global System for Mobile communication (GSM), and Enhanced Data for GSM Evolution (EDGE), and
wherein the second access protocol is another one of AMPS, DAMPS, GSM, and EDGE.

13. The method of claim 11, further comprising:
selectively connecting one of the plurality of first digital waveforms and the plurality of second digital waveforms at a time to the one or more common reconstruction filters.

14. The method of claim 11, wherein generating the plurality of first waveforms from first transmission data in accordance with a first access protocol comprises:
reading values from a first look-up table based on the first transmission data, and
wherein generating the plurality of second waveforms comprises:
reading values from a second look-up table based on the second transmission data.

15. The method of claim 11, wherein generating the plurality of first waveforms from first transmission data in accordance with a first access protocol comprises:
over-sampling the first transmission data at a multiple of its symbol rate, the multiple being based on the first access protocol, to output first over-sampled data;
interpolating the first over-sampled data at another multiple of its sampling rate, the another multiple being based on the first access protocol, to output first interpolated data; and
converting the first interpolated data to the first waveforms.

16. The method of claim 15, wherein generating the plurality of first waveforms from first transmission data in accordance with a first access protocol further comprises:
filtering the first over-sampled data to restrict its bandwidth.

17. The method of claim 15, wherein generating the plurality of second waveforms comprises:
over-sampling the second transmission data at a multiple of its symbol rate, the multiple being based on the second access protocol, to output second over-sampled data;
interpolating the second over-sampled data at a multiple of its sampling rate, the multiple being based on the second access protocol, to output second interpolated data; and
converting the second interpolated data to the second waveforms.

18. The method of claim 15, wherein generating the plurality of second waveforms from second transmission data in accordance with a second access protocol comprises:
interpolating the second transmission data at a multiple of its sampling rate, the multiple being based on the second access protocol, to output second interpolated data; and
converting the second interpolated data to the second waveforms.

19. The method of claim 11, wherein said filtering one of the first and second waveforms to produce an analog waveform comprises:
filtering, by one or more low-pass filters with a bandwidth of 200 kHz or more, one of the first and second waveforms.

20. A transmitter in a mobile terminal, comprising:
a plurality of waveform generators, each waveform generator generating a waveform from transmission data according to a different access protocol; and
a common reconstruction filter coupled to each of the plurality of waveform generators to receive a waveform from one of the plurality of waveform generators and to filter the received waveform.

21. The transmitter of claim 20, wherein the common reconstruction filter comprises:
a passive low pass filter with a bandwidth of 500 kHz or more.

22. The transmitter of claim 20, wherein the common reconstruction filter comprises:
an active low pass filter with a bandwidth of 500 kHz or more.
